(19) United States
(12) Patent Application Publication
(10) Pub. No.: US 2009/0031518 A1
(43) Pub. Date: Feb. 5, 2009

(54) Tool for Finishing Drywall Corners with Elongated Blade Members and Extended Handle

(76) Inventor: Larry Salvino, Wauconda, IL (US)

Correspondence Address: VEDDER PRICE P.C., 222 N. LASALLE STREET, CHICAGO, IL, 60601, US

(21) Appl. No.: 11/833,904

(22) Filed: Aug. 3, 2007

(51) Int. Cl. B05C 17/10

(52) U.S. Cl. 15/235.7

(57) ABSTRACT

A tool for finishing viscous masses, such as joint compound and tape, to inside and outside corners of drywall edges includes elongated blade members with an elongated handle. The elongated blade members and elongated handle provide for the effective manipulation of the tool while moving upwardly or downwardly in a corner without the requirement of changing the tool to another hand of the user or inverting it to complete the finishing the corner.

### BACKGROUND OF THE INVENTION

1. Field of the Invention

This invention relates to a tool for finishing drywall surfaces, and more specifically, a handheld tool designed for finishing drywall surfaces where the surfaces meet at an angle.

2. Description of the Prior Art

Drywall is a sheet of compressed gypsum-like material sandwiched between two sheets of heavy paper. The product, which typically is produced in a certain size, for example, 4 foot by 8 foot sections, is used efficiently and inexpensively to create interior walls in buildings. A smooth plaster like appearance is desired when installing the drywall. The rough seams between contiguous sheets of the drywall must be covered as well as the corners where sheets meet to form an angle. Both of these areas must be finished so that they have the appearance and smoothness of plaster. Drywall seams are typically taped and thereafter a taping or finishing compound is then smoothed over the taped area to render a smooth surface so that the seam appears to disappear. It is difficult to apply the finishing compound in a corner. Conventionally, there are trowels for smoothing the joint compound used on drywall or gypsum board panels that comprise a thin sheet metal member that is bent along a midline to define two planar surfaces meeting at a fixed 90° angle. A handle is affixed to the sheet metal member to facilitate the positioning of the trowel in a corner joint and drawing it along the corner joint as joint compound is applied. The trowels are used for finishing defined internal corners where drywall meets as well as for finishing external corners. Both internal corner and external corner trowels may be used at the top of the joining of the sidewalls, for example, near a ceiling, and moved downwardly to the bottom of the joining of the sidewalls to the floor of the structure. In the movement of the trowel from top to bottom, the user must stop at some point along the corner joint to remove the trowel from the corner joint and place it upside down so that the top of the trowel is pointing towards the floor or lower sidewall members to continue the finishing process to the lower sidewall members or floor. This procedure takes extra time and skill to smooth any accumulation of joint compound where the trowel is lifted off the corner and replaced on the corner in an inverted position to continue the finishing process. It would be advantageous to have a trowel for applying drywall joint compound that is capable of being positioned and moved from the top of the corner joint all the way to the bottom of the joint without the necessity of removing the trowel from contact with the corner joint and repositioning it to continue the finishing process.

### SUMMARY OF THE PRESENT INVENTION

In accordance with the present invention, an improved tool is provided for finishing drywall surfaces, particularly where the surfaces are joined to form a corner. The tool has elongated blade members defining a blade angle and an elongated handle. The handle is attached to top and bottom portions of the blade members and extends substantially to the bottom edges of the blade members. This construction allows for the effective manipulation of the tool so that the user does not have to change the grip or change hands grasping the handle to move the tool to from one end or a corner to another end of a corner, for example, the motion of moving the tool from the corner near the top of the corner to the bottom of the corner. The tool does not have to be inverted by the user to reach the lower corner because the blade members and handle are sufficiently elongated to reach the bottom or lower corner by the user without interruption of the motion of finishing the joint compound, tape and corner.

It is an object of the present invention to provide an effective tool for finishing drywall corners without the need to invert the tool or having the user change the tool to another hand or reposition the tool for completion of the finishing the corner.

It is another object of the present invention to provide blade members that define the blade angle for finishing a corner of drywall. The tool can be provide to fit different corner angles.

These and other objects and advantages of the present invention, as well as details of an illustrative embodiment, will be more fully understood from the following description and from the drawings.

### BRIEF DESCRIPTION OF THE DRAWINGS

The present invention will be understood and appreciated more fully from the following detailed description taken in conjunction with the drawings in which:

FIG. 1 is a perspective view of one embodiment of the present invention showing an elongated blade and handle;

FIG. 2 is a top view of one embodiment of the present invention;

FIG. 3 is a side view of one embodiment of the present invention;

FIG. 4 is a side view of one embodiment of the present invention wherein it is affixed to an inside corner of a joining of two pieces of drywall;

FIG. 5 is a representation of a side view of an embodiment of the present invention for finishing joint compound on drywall wherein the embodiment is positioned so that it may proceed from the top of the drywall joint to the bottom of the drywall joint so that it remains in contact with the joint compound and drywall corner so that it finishes the corner without being removed therefrom;

FIG. 6 is a side view of another embodiment of the present invention wherein two blade members are attached by one handle for efficient finishing of joint compound on a drywall joint;

FIG. 7 is a side view of the embodiment of the present invention having two blade members attached to a handle for finishing outside corners.

FIG. 8 is a perspective view of an embodiment of the present invention with two blades showing flanges on the inside edges of the blades to ensure smooth finishing of the joint compound;

FIG. 9 is a perspective view of another embodiment of the present invention designed for finishing outside corners;

FIG. 10 is another embodiment of the present invention showing a T handle;

FIG. 11 is another embodiment of the present invention showing a perspective view of a one piece plate with centered section areas with flanges.

### DETAILED DESCRIPTION OF THE PREFERRED EMBODIMENTS

The present invention provides, among other things, a new and improved apparatus for distributing joint compound or other similar adhesive-type viscous mass to a surface corner. The embodiments of the present invention are easy to use and construct and prove exemplary for facile and efficient distribution of the joint compound or viscous mass to surface corners.

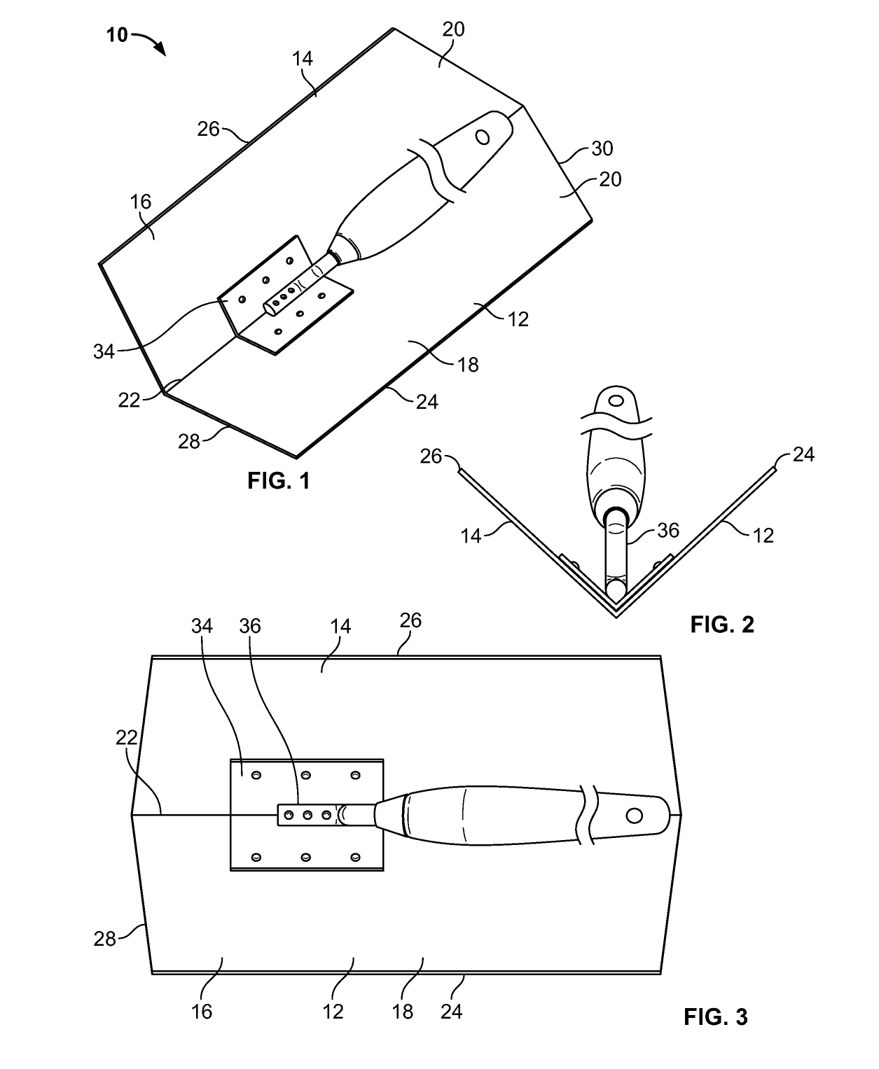

Turning now to the drawings, in which like reference characters indicate corresponding elements throughout the several views. Attention is first directed to FIGS. 1-3, which illustrate perspective top and side views of tool 10 for distributing a viscous mass, for example, joint compound, to a surface corner. The tool of the present invention is capable of applying the joint compound, also known as taping or finishing compound or “mud,” in a smooth and uniform layer to mask the rough edges of a corner and any tape that may have been applied to the seam or joint formed from the meeting of two wallboard pieces to form a corner. The finishing also covers stapes or nails and provides smoothness to the surface area.

Tool 10 includes first 12 and second 14 elongated blade members for spreading the joint compound. Blade members 12 and 14 have an upper portion 16, midportion 18, and lower portion 20. The blade members are typically constructed of sheet metal or other suitable metal or rigid plastic or rubber.

Blade members 12 and 14 meet at joint 22, which forms the desired angle for finishing a corner joint. The tool 10 may be constructed to finish inside angles and outside angles where wallboard meets to form a corner. The angle of the joint may vary. Tool 10 can be constructed to be operatively associated with various corner angles. With no intention of being limitative, the illustrations show embodiments of the present invention having a joint angle of about 90°. Blade 10 includes outside edged 24 and 26 of the blades and top edge 28 and bottom edge 30 of the blades 12 and 14.

In order to accomplish the objections of the invention, it is necessary that tool 10 has a handle 32 so that tool 10 can be manipulated with ease by the user. Handle 32 and tool 10 may be made as a unitary member, thereby simplifying construction and costs of the tool. Typically, however, it can be attached to connector member 34, which joins each blade member. Connector 34 may be attached to blade members 12 and 14 by soldering, rivets, bolts, or any other conventional means that would be compatible with the construction of the tool. Neck 36 or other suitable means may be used to attach handle 32 to the connector 34. Handle 32 can be attached to connector 34 by conventional means, including bolts, soldering, etc.

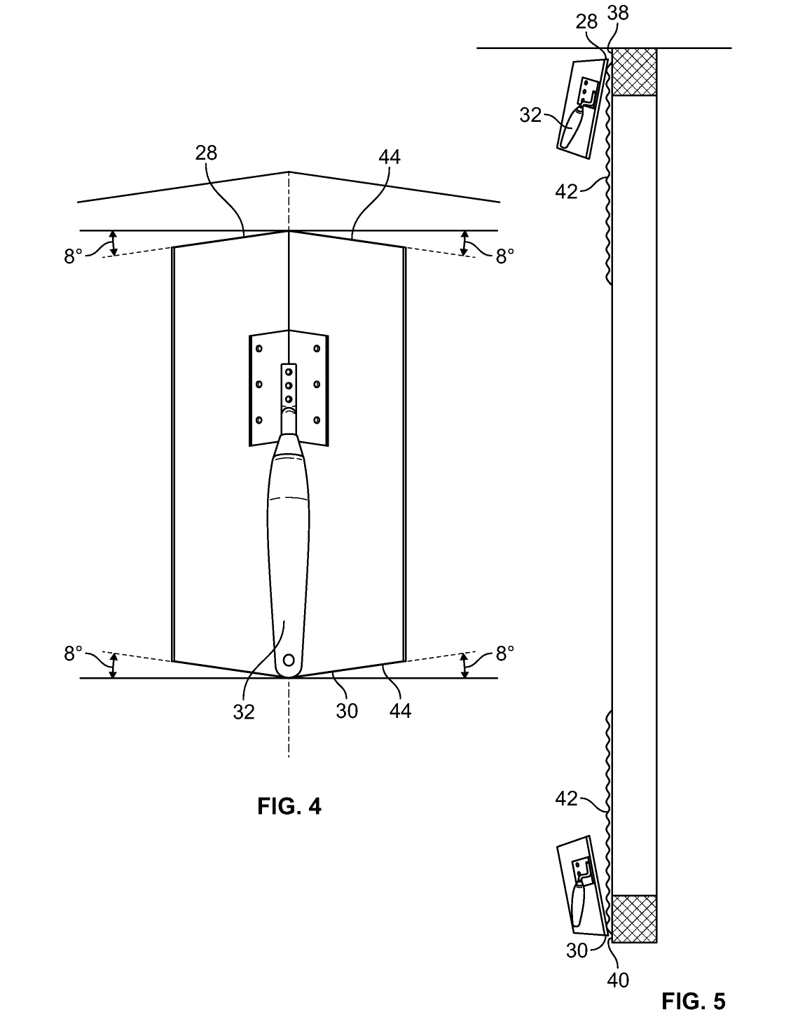

Handle 32 is attached to connector member 34 as shown in FIGS. 1-5. Handle 32 and connector member 34 are attached to blade members 12 and 14 above midportion 18 and in upper portion 16 of blade members 12 and 14. The movement of handle 32 on blade members 12 and 14, in the upper portion 16, allows for an elongated handle extending from the connector member 34 to the bottom edge 30. The long length of handle 32 allows the user to manipulate tool 10 with one hand when starting at one end 38 to a second end 40 of the wall, as shown in FIG. 5, a sectional view of a corner and tool 10. Top edge 28 of blade members 12 and 14, when starting at one end 38, or the top of the wall, is pressed against joint compound 42 for finishing the corner. Tool 10 is pressed against joint compound 42 as it is moved downwardly to the second end 40. As tool 10 moves in the corner, it can be flattened against the corner for a smooth, finishing effect. As tool 10 is moved to the second end 40 or bottom of the wall, the bottom edge is firmly pressed in the corner and top edge 28 is lifted in order to complete the smooth finish of the corner. With elongated handle 32, the user need not stop at some point between the one end 38 and the second 40 to change hands and manipulate the handle 32 to second end 40 or bottom of the wall. The tool does not have to be inverted to complete the finishing process. Elongated handle 32 allows for a more efficient and quicker finishing of a corner than conventional trowels or tools.

To ease the manipulation of tool 10, top edge 28 and bottom edge 30 are offset by angle 44 by about 8° from a level plane at joint 22 to allow for facile manipulation of handle 32.

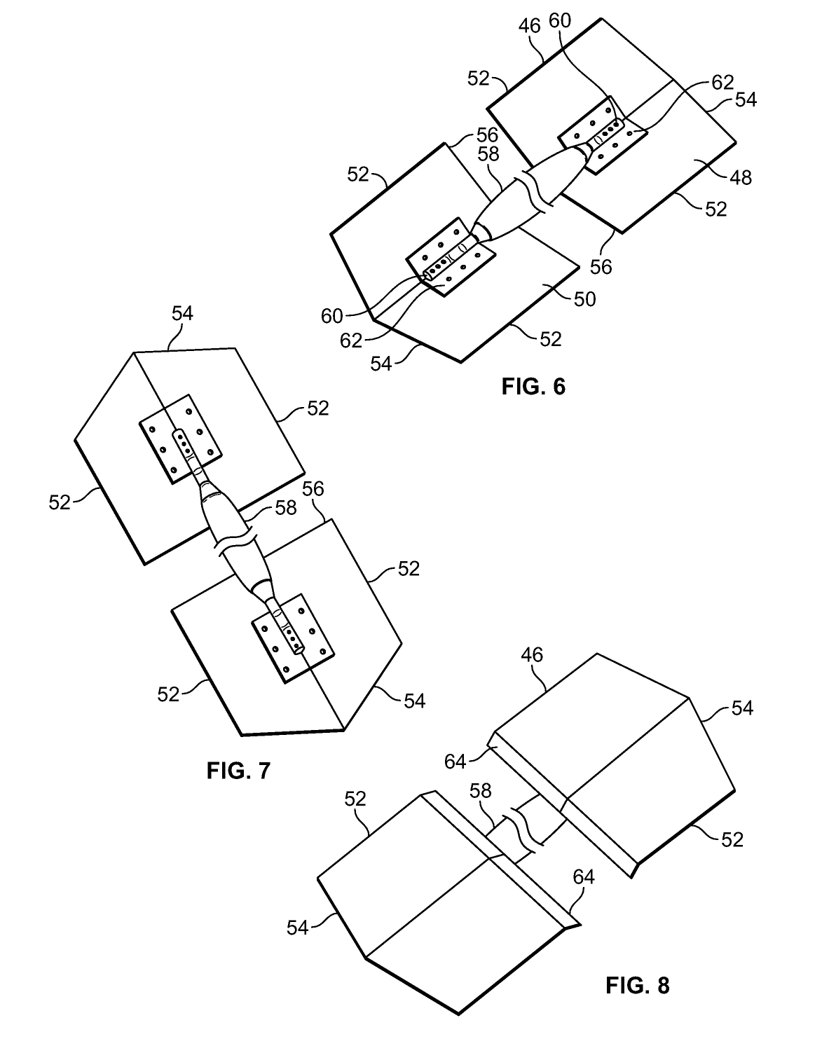

An alternate embodiment is shown in FIGS. 6-8. Two-blade tool 46 has first blade 48 and second blade 50. Each blade includes side edges 52, top edges 54, and bottom edges 56. The two blades are connected by elongated handle 58, which is attached to each blade by necks 60 and connector members 62. The two-blade tool 46, as shown in FIG. 6, is adapted for use with an inside corner of the drywall joint. FIG. 7 illustrates two-blade tool 46 adapted for use with an outside corner.

Elongated handle 58 provides for the effective manipulation of tool 46 for efficient finishing of joint compound, tape, and the drywall corner as previously described. The user does not have to change hands or stop in the motion of smoothing and finishing when moving tool 46 from a higher to a lower position or vice versa in the wallboard corner, whether the angle is an inside or outside corner.

Another embodiment is shown in FIG. 8. Two-piece tool 46 has flanges 64 as an added element for smoothing joint compound as the tool finishes the compound, tape, and drywall corner.

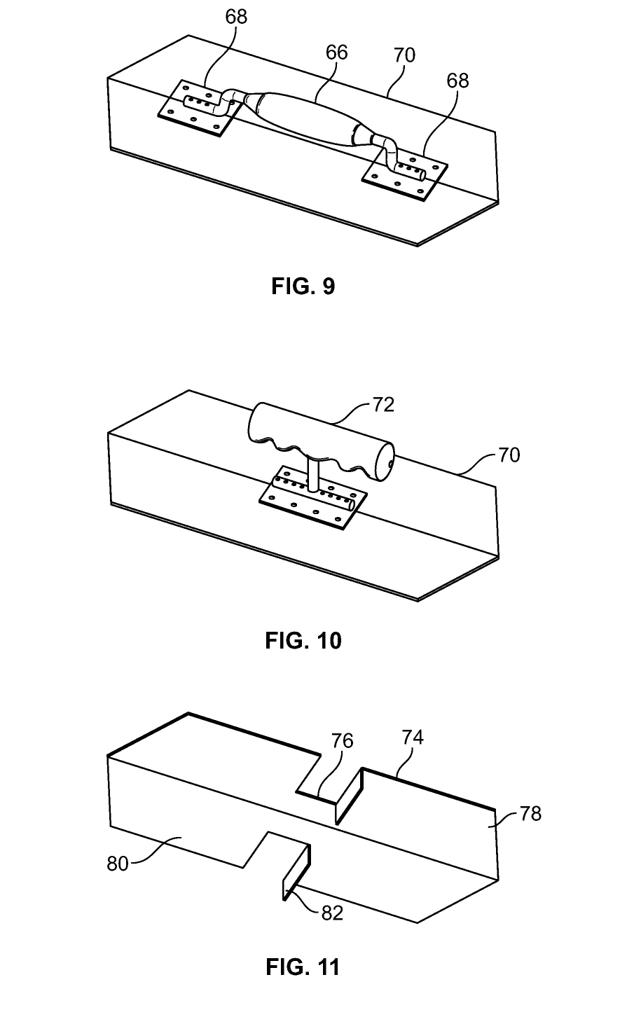

FIG. 9 illustrates a one-piece tool 70 with extended handle 66 with two connection members 68 for facile use as previously described with other embodiments.

FIG. 10 illustrates another embodiment of a one-piece tool 70 including a T handle 72 for manipulating tool 70 as previously described with other embodiments.

FIG. 11 is another embodiment of a one-piece tool with a neck 76 with a handle not shown. Tool 74 has a first end 78 and a second end 80 on either end of neck 76, which has a reduced width relative to the first and second ends or portions. Flanges 82 provide for a smooth finishing effect when the tool is manipulated in a drywall corner. The formation of neck 76 provides a light tool and therefor facilitates the finishing of joint compound and tape in the drywall corner.

The present invention has been described with reference to preferred embodiments. However, those skilled in the art will recognize that changes and modifications may be made in the described embodiments without departing from the true nature and scope of the present invention. Various changes and modifications to the embodiments herein chosen for the purpose of illustration will readily occur to those skilled in the art. To the extent that such modification and variations do not depart from the spirit of the invention, they are intended to be included within the scope thereof, which is assessed only by a fair interpretation of the following claims.

1. A tool for finishing drywall surfaces where the surfaces are joined to form a corner, comprising:
a. first and second elongated blade members, each of said blade members having a first side and a second side constructed to form a joint defining a blade angle, and top and bottom edges,
b. a top portion and bottom portion on said blade members,
c. an elongated handle having one end connected to the top portion of said first and second blade members, and
d. the handle extending from the one end at the top portion of said blade members to an opposed end at the bottom edges of the blade members.

2. A tool according to claim 1 wherein the elongated handle allows a user to manipulate the tool to finish joint compound on drywall surfaces without removing the tool from the drywall surfaces.

3. A tool according to claim 1 wherein the handle is attached to the top portion of the blade members by a connector plate.

4. A tool according to claim 1 wherein the blade angle is for an internal corner angle or external corner angle.

5. A method of using a tool for finishing drywall surfaces where the surfaces are joined to form a corner, including:
a. first and second elongated blade members, each of said blade members having a first and second sides constructed to form a joint defining a blade angle, and top, bottom, and outside edges,
b. a top portion and bottom portion on said first and second elongated blade members,
c. an elongated handle having one end connected to the top portion of said blade members extending from the top portion of said blade members to an opposed end at the bottom edges of the blade members for finishing drywall surfaces where the surfaces are joined to form a corner comprising, applying a tape to the drywall corner having a first end and a second end, contacting the tool at one end of the corner and moving it to the other end while finishing the joint compound on the corner without removing the trowel from the corner.

6. The method according to claim 5, wherein the tool has an elongated handle that extends to the bottom edge of the blade members.

7. The method according to claim 5, wherein the method allows a user to provide a smooth finish to the corner, wherein the user does not change grip on the handle.

8. A tool for finishing drywall surfaces where the drywall surfaces are joined to form a corner comprising:
a. first and second blade members, each of said blade members having a first side and second side constructed to form a joint defining a blade angle and top, bottom, and side edges, and
b. an elongated handle having one end connected to the first and second blade members, wherein an opposed end of the handle does not extend beyond the bottom edges of the blade members.

9. A tool according to claim 8, wherein the elongated handle allows a user to provide a smooth finish to a corner, where the user does not change grip on the handle.

10. A tool according to claim 8, wherein the blade angle is for an internal corner angle or external corner angle.

11. A tool for finishing drywall surfaces where the surfaces are joined to form a corner, comprising:
a. a blade member having an upper portion and lower portion constructed to form a joint defining a blade angle with top and bottom edges;
b. a neck connecting the upper and lower portions of the blade member;
c. an elongated handle connected at its first end to the upper portion and at its second end to lower portion of the blade; and
d. the handle extending from the upper portion of said blade member to the the bottom edge of the blade member.

12. A tool according to claim 11, wherein the blade member has side edges on the upper and lower portions.

13. (canceled)

14. A tool according to claim 11, wherein the neck has a reduced width relative to the upper and lower portions.

15. (canceled)

16. A tool according to claim 1, wherein the top and bottom edges of the blade members are offset from a horizontal plane at the joint of the blade members.

17. (canceled)

18. A tool according to claim 8, wherein the top and bottom edges of the blade members are offset from a horizontal plane at the joint of the blade members.
